(19) United States
(12) Patent Application Publication
(10) Pub. No.: US 2007/0085776 A1
(43) Pub. Date: Apr. 19, 2007

(54) Display apparatus and display panel

(76) Inventors: Mikio Shiraishi, Yokohama (JP); Eiji Miwa, Yokohama (JP); Toshiyuki Kurita, Yokohama (JP); Katsumi Ashizawa, Yokohama (JP)

Correspondence Address: MCDERMOTT WILL & EMERY LLP, 600 13TH STREET, N.W., WASHINGTON, DC, 20005-3096, US

(21) Appl. No.: 11/523,081

(22) Filed: Sep. 19, 2006

(30) Foreign Application Priority Data
Oct. 13, 2005 (JP) 2005-298310

(51) Int. Cl. G09G 3/22

(52) U.S. Cl. 345/74.1

(57) ABSTRACT

An electron emission type display apparatus has on a flat plane a matrix layout of multiple light-emitting elements which are connected to cross-points of longitudinal and lateral common electrodes, for sequentially turning on a line of light-emitting elements connected to a common electrode. In such the device, distortion takes place in drive waveform since a low-pass filter (LPF) is formed by a combination of the wiring resistance of the common electrode and the capacitance of a light-emitting element. To avoid such waveform distortion, the width of a light-emitting element driving voltage pulse is caused to be greater than the width of a scan voltage pulse.

### INCORPORATION BY REFERENCE

The present application claims priority from Japanese application JP2005-298310 filed on Oct. 13, 2005, the content of which is hereby incorporated by reference into this application.

### BACKGROUND OF THE INVENTION

The present invention relates to display apparatuses for displaying television (TV) images by use of a flat face panel display unit with electron emission elements.

In display apparatuses such as TV receivers, advances in display units bring challenges for development of matrix type display apparatuses using field emission elements or electron emission elements or else as the flat panel (flat-face panel type) display unit. These matrix type display apparatuses are usually designed so that a large number of light-emitting elements which constitute picture elements or “pixels” are laid out in a matrix form for performing visual display operations. A single light-emitting element is generally made up of an electron source for releasing electrons into a vacuum space and a layer of fluorescent material which is applied a high voltage for acceleration of the electrons thus released and which performs light emission due to excitation by such electrons. A display screen is configured from a matrix of rows and columns of display operation-performing elements, which are disposed on a flat plane of the display screen and are connected by conductive wiring lines that extend longitudinally and laterally. One typical approach to enabling operation of respective light-emitting elements is to employ a so-called matrix drive technique for selectively activating a light-emitting element residing at a cross-point or “intersection” of the longitudinal and lateral conductive wiring lines.

In the case of driving multiple light-emitting elements which are laid out in the matrix on the flat plane, the electrical resistance of wiring lines becomes hardly negligible. More specifically, those lines with a relatively short length in close proximity to the end portion of a drive unit of the display screen are appreciably different in wiring resistance from other wiring lines with an increased length. This wire resistance difference causes the potential drop-down of a voltage applied thereto, which in turn results in occurrence of image quality deterioration, such as brightness irregularities. Known techniques for correction of this image quality reduction are disclosed, for example, in JP-A-2001-324957 and JP-A-2005-115314.

JP-A-2001-324957 discloses therein a scheme for detecting a drive voltage decrease due to the presence of wire resistance and for feeding it back to the voltage on a supply side to thereby finally apply a prespecified drive voltage.

JP-A-2005-115314 discloses a technique for application of a voltage which is designed to increase in its pulse width with an increase in distance of an electrode from a drive circuit operatively associated therewith.

### SUMMARY OF THE INVENTION

Unfortunately, the above-stated prior known techniques fail to take into consideration any influence of capacitive components of the light-emitting elements. Specifically, the prior art schemes do not sufficiently recognize the fact which follows. In case the waveform of a drive voltage is of a rectangle shape, the actually applied waveform has a delay, resulting in unwanted creation of a shape with the lack of a portion of the waveform. This leads to the failure of application of a sufficient voltage, which makes it impossible to finally obtain any intended brightness or luminance.

The present invention provides a technique suitably adaptable for improvement of the display image quality by successfully correcting or “amending” the image quality with respect to image quality deterioration otherwise occurring due to the presence of capacitive components of the light-emitting elements.

To this end, this invention provides a display apparatus which includes a plurality of scan lines, a scan line drive circuit connected to at least either one of right and left ends of the plurality of scan lines for sequentially applying a scan voltage pulse to the scan lines, a plurality of signal lines, a signal line drive circuit connected to the plurality of signal lines-for applying to these signal lines a drive voltage pulse pursuant to an input image signal, an electron source connected to respective intersections of the plurality of scan lines and the plurality of signal lines for giving off electrons in accordance with a potential difference between the scan voltage and the drive voltage, and a control unit, wherein the control unit is operative to control the scan line drive circuit and the signal line drive circuit in such a way that the drive voltage pulse becomes greater in width than the scan voltage pulse.

With such an arrangement, it becomes possible to apply an appropriate drive voltage in a way pursuant to a delay of waveform due to capacitive components. Furthermore, for example, in the drive of a line which is large in waveform delay, that is, a line with its delay becoming larger with an increase in distance from a drive element-side end face, control is provided to ensure that the drive voltage becomes greater in pulse width than the scan voltage.

According to this invention, it is possible to provide a technique adaptable for the improvement of the display image quality by effectively correcting the image quality with respect to image quality deterioration occurrable due to the presence of capacitive components of light-emitting elements.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a perspective view of a display apparatus in accordance with a first embodiment of the present invention.

FIG. 2 is an enlarged cross-sectional diagram of part of a display panel in accordance with the first embodiment of this invention.

FIGS. 3A through 3E are perspective views of part of the display panel in accordance with the first embodiment of the invention, wherein each diagram depicts an internal electrode configuration of the panel.

FIG. 4 shows an entire configuration of a drive circuit of the display panel in accordance with the first embodiment of the invention.

FIGS. 5A and 5B are circuit diagrams each showing a configuration of one of those light-emitting elements making up the display panel in accordance with the first embodiment of this invention.

FIG. 6 shows a circuit configuration of a low-pass filter of one light-emitting element used in the display panel in accordance with the first embodiment of the invention.

FIG. 7 is a graph showing a current versus voltage characteristic curve of the light-emitting element in the display panel in accordance with the first embodiment of the invention.

FIGS. 8A-8B are waveform diagrams each showing some drive signal waveforms of one light-emitting element for use as a pixel in the display panel in accordance with the first embodiment of the invention.

FIG. 9 shows some major drive waveforms of an entirety of the display panel in accordance with the first embodiment of the invention.

FIG. 10 depicts an overall configuration of a drive circuit of a display panel in accordance with a second embodiment of this invention.

FIGS. 11A-11B are waveform diagrams each showing drive voltage waveforms to be applied to one of the light-emitting elements making up the display panel in accordance with the second embodiment of the invention.

FIG. 12 shows an overall configuration of drive circuitry of a display panel in accordance with a third embodiment of the invention.

FIGS. 13A-13B are waveform diagrams each showing drive voltage waveforms to be applied to one of the light-emitting elements making up the display panel in accordance with the third embodiment of the invention.

### DETAILED DESCRIPTION OF THE EMBODIMENTS

Several embodiments of the present invention will be described while referring to the accompanying drawings below. Note that those constituent parts or components with similar functions are denoted by identical reference numerals, and repetitive explanations thereof will be eliminated for brevity purposes of the description.

### Embodiment 1

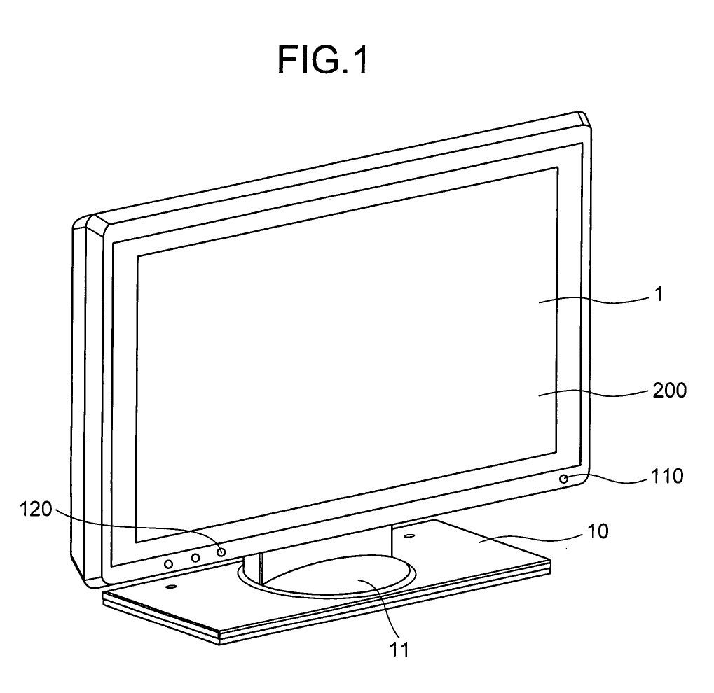

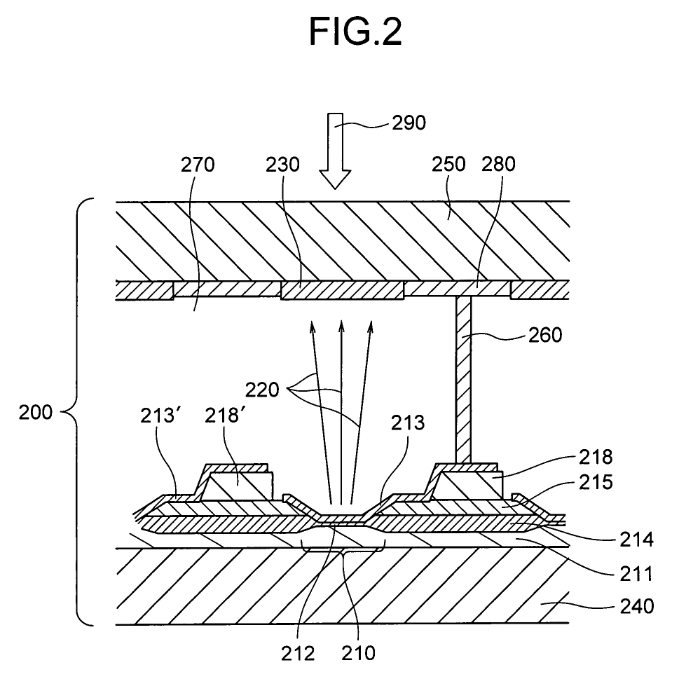

FIGS. 1 to 8 are explanation diagrams of a first embodiment of this invention. Explanation will first be given of outline contents of an operation by using FIGS. 1 to 8; thereafter, individual operation contents will be set forth in a sequential order of FIG. 1, FIG. 2, et seq.

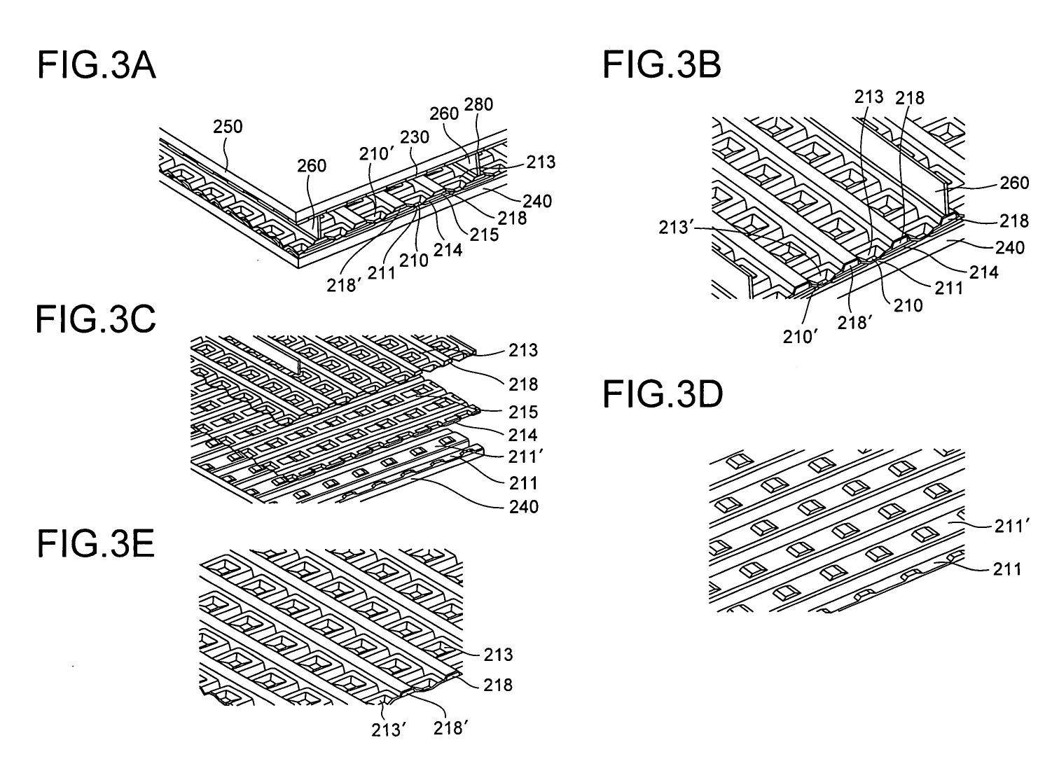

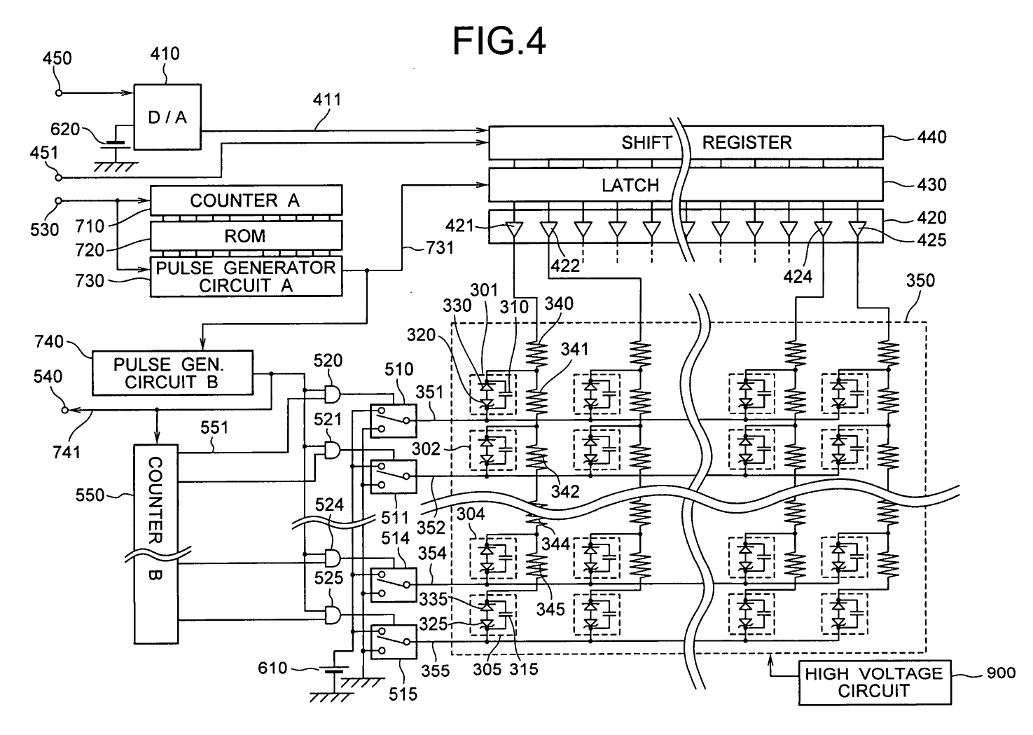

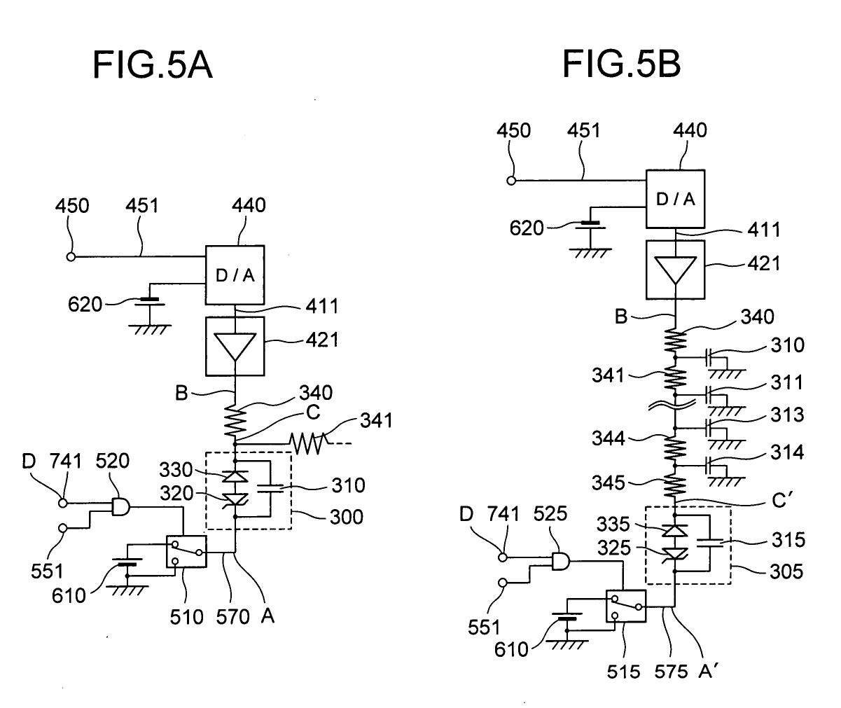

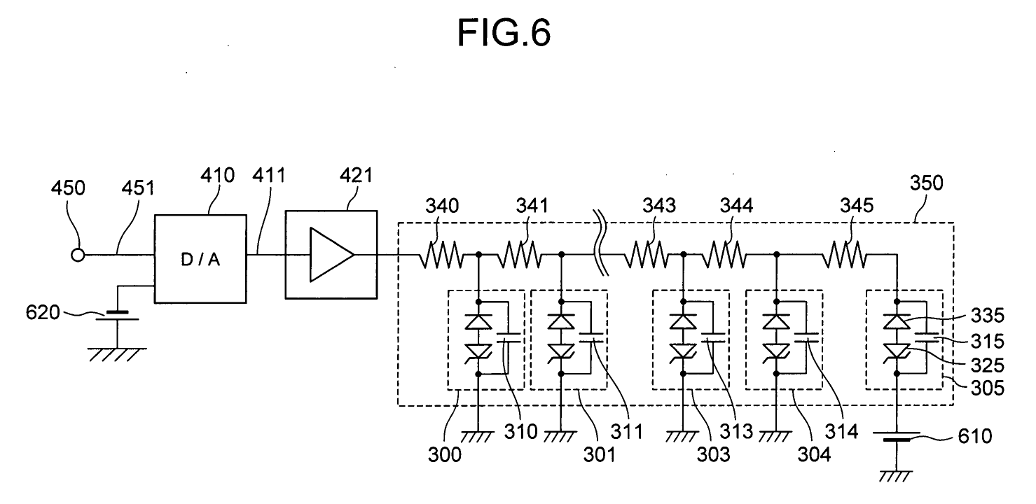

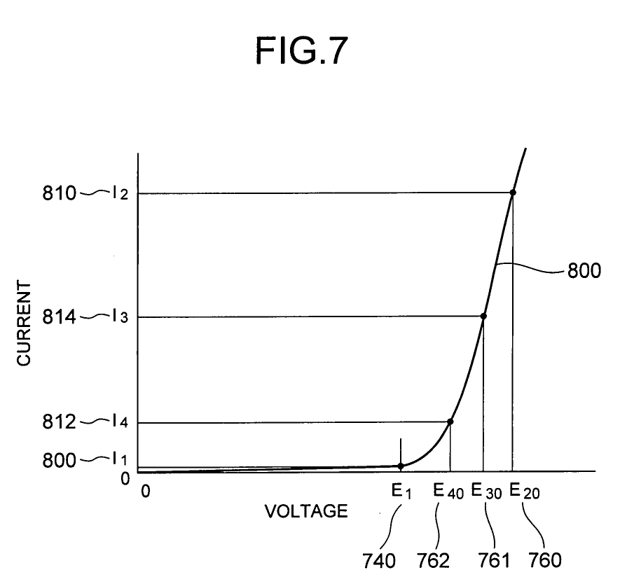

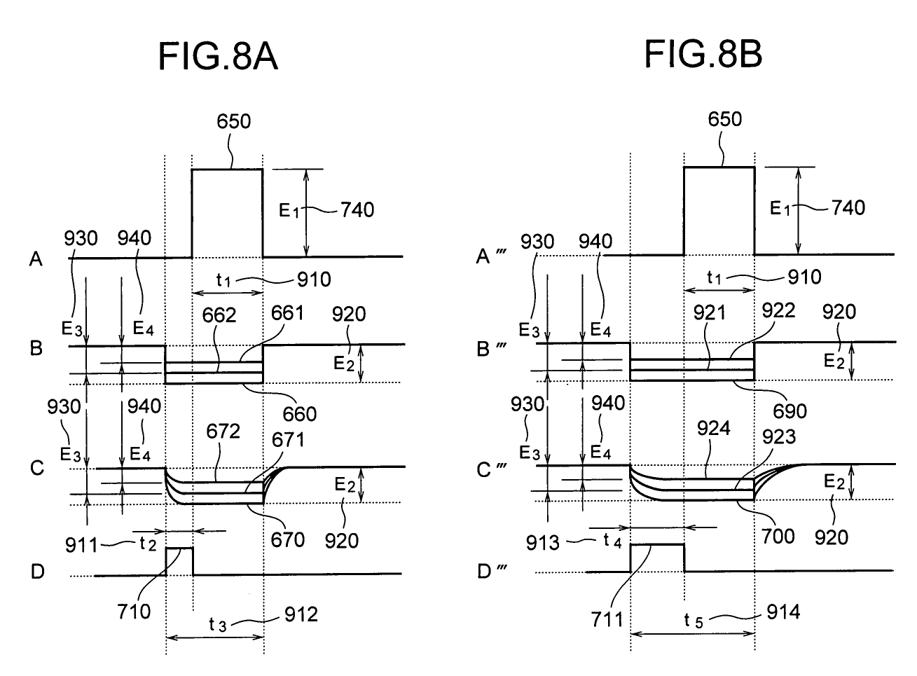

FIG. 1 is a diagram showing a perspective view of a matrix type display apparatus which is the first embodiment. In FIG. 1, the display apparatus 1 is in the state that it is supported by a base plate 10 for stable support thereof. FIG. 2 depicts an enlarged partial cross-sectional structure of a display unit of the embodiment shown in FIG. 1. Light-emitting elements for performing display operations are each structured from a combination of an electron emission portion 210—say, electron emitter—and a fluorescent material 230. FIGS. 3A to 3E are diagrams each showing a perspective view of the inside of an array of light-emitting elements. Electrical connection to the light-emitting elements is made by common electrodes which extend longitudinally and laterally in a matrix form, which electrodes are adequately selected to perform a light emission operation. A light emission operation is performed by a line-sequential lighting scheme, which simultaneously activates one line of elements which are connected in common to a single line of electrode. Sequentially switching this one-line lighting enables visual display of a one-screen image. FIG. 4 shows a circuit configuration of the entirety of a display panel. Circuits for driving the light-emitting elements are provided and located in two directions, i.e., on a data side with the presence of a data driver 420 and on a scan side in association with a scanning switch, e.g., switch A 510. Based on a counted line number, a predetermined numerical value that is stored in a read-only memory (ROM) unit 720 is sent to a pulse generation circuit A 730. In responding thereto, a signal having its pulse width corresponding to the line number is sent out toward a latch signal line 740. This time becomes a pause or “rest” time of one line. Furthermore, a voltage signal indicative of a fixed length of time period to be formed by a pulse generator circuit B is applied to a light-emitting element as a light emission time. An arrangement employed is that a sum of these rest time and light emission time becomes an operation time of one line while permitting the rest time to change depending on the number of a line to be displayed, resulting in the one-line operation time varying accordingly. FIGS. 5A-5B are diagrams each showing an equivalent circuit at a single light-emitting element, wherein FIG. 5A shows an equivalent circuit of a light-emitting element of the first line whereas FIG. 5B is an equivalent circuit of a light-emitting element of the 768-th line, for example. FIG. 6 is an explanation diagram of a delay circuit, which is formed of resistors and capacitors in the case of driving the light-emitting element of the 768-th line shown in FIG. 5B. FIG. 7 graphically shows a relationship of an application voltage of an electron emitter which is an element for performing light emission and a current flowing in the element, i.e., brightness. FIG. 8A shows drive voltage waveforms of light-emitting element in the first line, and FIG. 8B shows drive waveforms of light-emitting element in the 768-th line. The drive waveforms at the 768-th line, which is far from the drive unit, are such that delays occur at rising and falling pulse edges. In view of this, it is arranged to eliminate execution of any light emission operation within this time period and, instead, perform a light emission operation after arrival at a prespecified voltage.

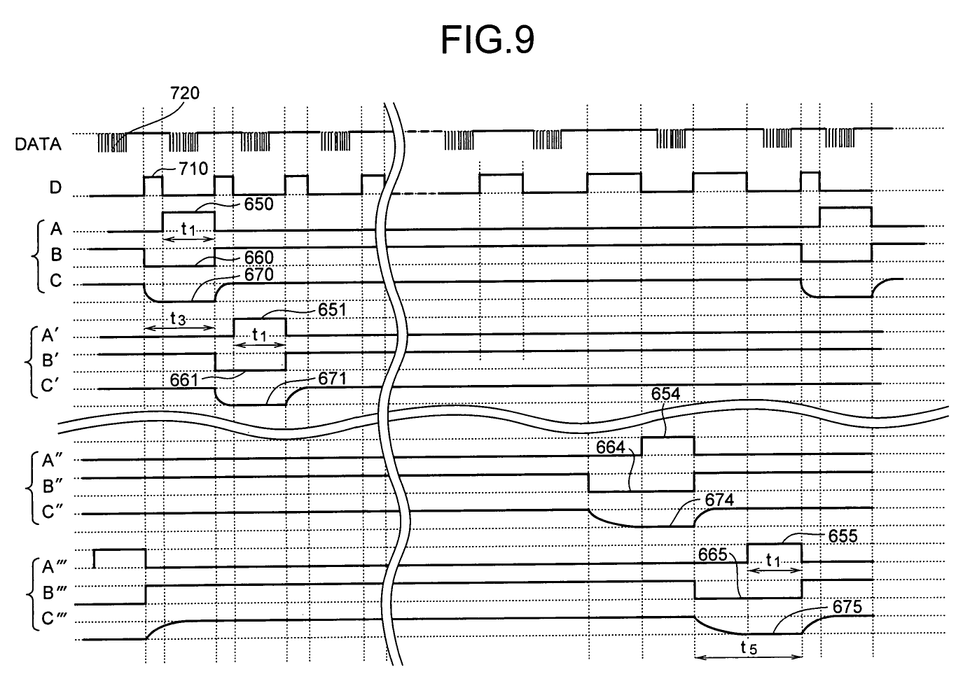

FIG. 9 is an explanation diagram showing operation waveforms of an entirety of the display unit. It is arranged to lengthen, gradually from the first line, the operation time per line, thereby avoiding influence on the display brightness even upon occurrence of per-line drive waveform delay.

Turning back to FIG. 1, the first embodiment will be described in detail.

FIG. 1 is a perspective view of a matrix type display apparatus which is the first embodiment. In FIG. 1, the display apparatus 1 is supported by its base plate 10. This apparatus is used in a way such that based on external TV broadcast radio waves or video signals as received by a signal input terminal 120, picture images are visually displayed on a display panel 200 of the display apparatus 1. Power-on/off is done by manual operations of a power switch 110. The display panel 200 of display apparatus 1 will be explained in the description while using an example which employs a matrix type flat panel display module having electron emission elements.

FIG. 2 shows a partial cross-section of the display panel 200 which is main part of the display unit 2 of the display apparatus 1 which is the first embodiment of this invention shown in FIG. 1. This diagram illustrates, in cross-section, one of a large number of elements as laid out on a flat plane in a matrix form.

A display operation is achieved by execution of a light emission operation which follows. Electrons that are released out of the electron emitter 210 are attracted to an acceleration high-voltage applying unit—e.g., an anode electrode 280 to which a high voltage of 5 kV (5000 V) or above is applied—and then reach the fluorescent material 230 by way of orbits 220 to excite the fluorescent material 230, thereby performing a light emission operation.

The display panel 200 is generally made up of a pair of spaced-apart glass substrates—namely, a cathode substrate 240 and an anode substrate 250—and components in a vacuum space 270 which is formed by spacers 260 that retain the distance between the substrates.

The electron emitter side 210 is structured from a thinned dielectric layer 212 and an upper electrode 213, wherein the layer 212 is part of a protective dielectric layer 214 which overlies a lower electrode 211 that is above the cathode substrate 240. The lower electrode 211 and the upper electrode 213 are spaced apart from each other by the dielectric layer 212 as interposed therebetween. By applying between them a predetermined voltage of 9 V or else as an example, electrons are given off toward the vacuum space 270. The amount of such electrons to be emitted by the application voltage is controllable. Additionally, the lower electrode 211, the protective dielectric layer 214, an interlayer mask 215, a thick-film electrode 218 and the upper electrode 213 are arranged beneath the spacers 260 in this order of sequence when viewed from the cathode substrate side.

A structure of the fluorescent material side is such that it is constituted from the fluorescent material 230 which is provided at the anode substrate 250 that is made of transparent glass and which has prespecified electrical conductivity and the anode electrode 280 which surrounds the fluorescent material that makes up a picture element or “pixel.” The anode electrode 280 is applied a high voltage of 5000 V or else, for example, which is supplied from external circuitry of the display panel 200 such as the acceleration high-voltage applying unit, wherein the voltage is applied between it and the lower electrode of the cathode substrate. At this time the fluorescent material 230 that is connected to the anode electrode 280 is at substantially the same potential. The previously stated electrodes emitted from the electron emitter 210 on the cathode side are attracted to the fluorescent material 230 that is coupled to the anode electrode 280 and progress within the vacuum space 270 as indicated by the orbits 220 to collide or impinge with the fluorescent material 230 to thereby perform a light emission operation by means of scintillation effects of the fluorescent material 230.

FIG. 2 shows an element with one of three primary color components making up a single pixel, e.g., a green element. One pixel is configured from three elements: the green element and, in addition thereto, two other primary color display elements, e.g., red and blue ones. Further, those pixels which are two-dimensionally disposed in longitudinal and lateral directions constitute an entire screen to be displayed. The electrodes for power feed to electron emitters are such that the lower electrode 211 extends laterally in this diagram whereas the upper electrode 213 is connected to the thick-film electrode 218 in this diagram, wherein the thick-film electrode extends in a direction perpendicular to the drawing sheet. In this way, by using the two-dimensionally disposed matrix-shaped electrodes to apply voltages to the electron emitters which constitute respective pixels, electrons are given off to cause the fluorescent material to emit light, thereby performing a display operation. FIGS. 3A-3E are diagrams each showing a perspective view of internal structure of the overall display panel of the display apparatus in accordance with the first embodiment. Explanation will be given of a detailed structure of electrode part while referring to respective interlayer arrangements in FIGS. 3A to 3E. In FIG. 3A, an entire structure will be described. In FIG. 3B, a structure of electron emitter will be explained. In FIG. 3C, an exploded view of the electron emitter is shown. In FIG. 3D, a structure of lower electrode unit will be discussed. In FIG. 3E, a structure of upper electrode unit will be described. First, explanation will be given with reference to FIG. 3A. FIG. 3A is an enlarged perspective view of a cross-section of a region as viewed from the whole panel having several elements for use as pixels.

The electron emitter 210 is structured from the lower electrode 211 that overlies the cathode substrate 240, the upper electrode 213, and the protective dielectric layer 214 interposed therebetween. As previously stated in FIG. 2, they are isolated by the thinned dielectric film 212 residing between an electron lower electrode 211 and an upper electrode 213. By applying between them a predetermined voltage of, e.g., 9 V or else, electrons are given off toward the vacuum space. The electrons thus emitted behave to finally approach the fluorescent material 230 on the anode substrate 250 side, thereby to perform a light emission operation.

As shown in FIG. 3A, a component that corresponds to a single pixel is made up of a plurality of elements, such as mutually neighboring electron emitters 210, 210′; furthermore, a large number of pixels as laid out two-dimensionally in longitudinal and lateral directions constitute an on-screen image displaying area. The size of one pixel at this time is arranged by the layout pitch of 500 μm, for example. The spacers 260 are disposed to ride on the thick-film electrode 218 at prespecified intervals (e.g., four elements, 2 mm, etc.). FIG. 3B is an enlarged perspective view of a structure of electron emitter of only the cathode substrate side. Additionally, the one that is the same as the above-stated cross-sectional view of FIG. 2 is shown in a three-dimensional (3D) fashion.

The thick-film electrode 218 is connected as a conductor which continuously extends from the upper-left to the lower-right direction in FIG. 3B while having no electrical conduction with its neighboring parallel thick-film electrode 218′ due to presence of electrical isolation therebetween. The thick-film electrode 218 is associated with upper electrodes 213 as connected thereto, which extends therefrom toward respective electron emitters.

FIG. 3C is an explosive view of a per-layer structure of electron emitters. The lower electrode 211 overlying the cathode substrate 240 is connected as a conductor that continuously extends from the lower-left toward the upper-right direction and is disposed in a direction at right angles to the direction of the thick-film electrode 218. At this time, lower electrodes are connected at downside of continued elements such as the electron emitters 210, 210′ of FIG. 3B and are electrically insulated from the lower electrode 211′ of a parallel element array of FIG. 3C with no electrical conduction therewith.

In this way, a plurality of thick-film electrodes 218 and lower electrodes 211 are laid out so that these cross together at right angles in a matrix form, wherein electron emitters 210 are disposed at cross-points or “intersections” thereof.

FIG. 3D is a perspective view of the lower electrodes only. FIG. 3E is a perspective view of a pattern of upper electrodes 213 and thick-film electrodes 218.

Note here that when activating a specific electron emitter 210, a thick-film electrode 218 and a lower electrode 211 which are connected to the electron emitter 210 may be selected. Upon activation of its neighboring electron emitter 210′, a thick-film electrode 218′ and lower electrode 211 which are connected to the electron emitter 210′ may be selected. In explanations to be given later, the connection destination of these thick-film electrodes 218 is assumed to be a scan drive circuit while supposing that the connection destination of the electron lower electrodes 211 is a data drive circuit.

Beneath the spacers 260, the lower electrode 211, protective dielectric layer 214, interlayer mask 215, thick-film electrode 218 and upper electrode 213 are arranged in this order of sequence from the cathode substrate side. The lower electrode 211 is formed by a deposition process to have a film thickness of 10 μm as an example. This thickness is far less than the thickness of thick-film electrode 218, e.g., 300 μm. Additionally the lower electrode 211 is designed for example to have a width of 400 μm, which is less than the pixel size of 500 μm, for a longitudinal screen size of 400 mm, although it is variable depending on a screen size. Thus, its internal electrical resistance is not negligible. For instance, the internal resistance becomes 1 kΩ for the longitudinal size of 400 mm. This causes the above-noted example to exhibit a difference in resistance of 1 kΩ between the nearest element connected to the drive circuit and an element furthest therefrom in a sense of circuitry. For this reason, it is necessary to perform correction of the internal resistance of the lower electrode.

FIG. 4 is a block diagram showing a circuit configuration of the entire display panel of the first embodiment. As certain element part for performing light emission will be later described with reference to FIGS. 5A-5B, explanation is given here of a scheme or “mechanism” for driving the light-emitting elements that are disposed in a two-dimensional (2D) matrix form while referring to FIG. 4. An operation of the entire display panel includes the steps of performing, in response to data corresponding to a screen to be displayed, light emission per line in the horizontal direction to thereby perform displaying, and sequentially switching this one-line light emission from the upper to the lower direction for completion of one screen display. A time period for the one-screen display is set, for example, to about 17 milliseconds (ms) in view of the afterimage of human eyes. Sixty screen images are displayed per second. At this time, since the one-line light emission time is set to permit displaying of 60 screens per second, the panel displays 768 lines, for example, within the time period of 17 ms, so it is expected to perform one-line display within an average time of about 0.022 ms. The light-emitting elements which are disposed in a matrix form within a panel 350 are connected to drive circuitry as disposed outside of the panel 350. This drive circuitry is operating under control of a control unit, not shown herein.

An operation of the overall drive circuit is performed in a procedure which follows. Firstly, at a first step, display data of one line is set up at each driver unit on the data drive side. Then, at a second step, a switch unit on the scan drive side is rendered operative to select a line to be activated and then apply a voltage thereto.

The data drive side operation at the first step will be explained sequentially from a data input stage. First, digital data as input from a data input terminal 450 is converted by a D/A converter 410 into an analog signal. The digital data is such that 4,095 (=1,365×3) per-pixel three-color data segments are supplied sequentially for a plurality of—e.g., 1,365—pixels in a single line along the horizontal direction of the displaying screen. Data switching is performed in a sequential order in response to a clock signal 451 as input thereto. At this time, a voltage to be supplied from a data power supply 620 is used as a reference voltage of the D/A converter circuit. A voltage range in which the analog signal after D/A conversion is variable in potential is defined by this data power supply 620. The data as has been converted to the analog signal is input to a shift register 440 and then retained and stored in the shift register 440 in response to the clock signal 451. In this way, 4,095 data items are input, which correspond to one linear array of pixels—e.g., 1,365 pixels—corresponding to one lateral line of the screen.

Next, the one-line data is held at a latch circuit 430. This latch circuit 430 is provided to ensure that the display data is kept unchanged during the displaying of the one-line data even while the next one-line data is in a process of input to the shift register. An output from the latch circuit 430 has outputs which correspond in number to the light-emitting elements for displaying, e.g., 4,095 elements. The output signal is subjected to impedance conversion at a driver 420 and then sent to the panel 350 by means of low impedance driving techniques, thereby to drive the light-emitting elements. At this time, a latch signal 731 to the latch circuit 430 is generated by the pulse generator circuit A 730 on the basis of an input from a terminal 530 for receipt of an externally transmitted scan signal. Further, as will be described later, the latch signal's width is modified in deference to the number of a line for light up. The latch circuit 430 is rendered operative upon rising up of the waveform of the latch signal 731. Regarding the width of latch signal, description will be given later.

Next, an operation of the switch unit on the scan drive side at the second step will be explained. The scan side which is another terminal of the panel 350 performs its operation in responding to the application of a prespecified voltage to one line to be selectively operated. For example, in order to drive a first line 351 of the panel 350, the switch A 510 is rendered operative. When it is in a rest state, the switch A 510 is set to its voltage 0 V side in a ground state, by way of example. When letting it operate, the switch A 510 is changed over to apply a voltage of a scan power supply 610 to the first line 351. This switch A 510 operates in responding to a pulse which is generated by a pulse generator circuit B 740 to have a predetermined length of about 0.017 ms, for example.

A signal as output from the pulse generator circuit B 740 is also supplied to a counter B 550. At a count-up circuit of the counter B 550, it counts up the number of input pulses and performs output toward the lines to be driven sequentially. An example is that when a first pulse of the first line is input, a signal is output to a signal line as connected to a gate A 520. Upon input of a second pulse, a signal is output to a signal line connected to a gate B 521, which is in charge of the second line. Upon input of the 768-th pulse, a signal is output to a signal line connected to a gate D 525, which is in charge of the 768-th line. In this way, the counter B 550 sequentially counts up the pulses of, from the first to 768-th line for example, outputs signals to respective output lines, and then selects a line to be operated, i.e., activated for light emission.

Here, explanation is given of the entire operation by turning back to an upstream side. A signal for startup of a one-line display operation operates with the pulse signal from the scan input terminal 530 as a trigger. The scan signal is sent from the control unit (not shown) once at a time whenever a one-line operation is done.

The input pulse-shaped signal is sent to a counter A 710 and the pulse generator circuit A 730. At this time, the counter A 710 counts up the number of input pulses and then sends its result to ROM 720 as a line number. At ROM 720, the information being stored therein is read out of it based on the counted line number and is then sent as pulse width data to the pulse generator circuit A 730. The pulse generator circuit A 730 is responsive to receipt of the pulse width data as sent thereto, for outputting to a latch signal line 731 certain pulse width values; for example, 0.001 ms for the first line, 0.005 ms for the 374-th line, and 0.009 ms for the 768-th line.

The pulses of the latch signal are again pulsed or “repulsed,” by the pulse generator circuit B 740 for transmission to the counter B 550. The counter B 550 switches between lines to be sequentially output on a per-latch signal basis. More specifically, the initially identified first output line becomes a first line portion, for permitting a line connected to the gate A 520 to operate. At this time, the gate A 520 takes AND operation of a pulse being sent from the pulse generator circuit B 740 and a signal as sent from the counter B 550, and then sends its output to the switch A 510. During a light emission operation of the first line, the switch A 510 is made operative within a time period corresponding to the width of a pulse to be output from the pulse generator circuit B 740, e.g., for 0.017 ms, to apply the voltage of the scan power supply 610, e.g., 9 V, to a scan line A 351. During an operation of the second line, the gate B 521 is rendered operative for activation of a switch B 511 to thereby drive a scan line B 352. With such procedure, during an operation of the 768-th line, a scan line D 355 is driven, resulting in completion of a display operation of one screen.

At the control unit (not shown), upon receipt of a signal from a scan terminal 540 for take out of the signal of the pulse generator circuit B 740, it determines that the one-line operation is ended, and then inputs a pulse for use as a startup signal to a scan signal terminal 530 that is expected to initiate the next one-line operation. Within this session, the time of one-line operation becomes a total sum of the above-stated latch signal by means of the pulse generator circuit A 730 and the scan signal due to the pulse generator circuit B 740. The one-line operation time is such that at the first line for example, the latch signal width is 0.001 ms and the scan signal width is 0.017 ms so that a total time is 0.018 ms. At the second line for example, the latch signal width is 0.005 ms and the scan signal width is 0.017 ms so that the one-line operation time becomes 0.022 ms in total. At the 768-th line for example, the latch signal width is 0.009 ms and the scan signal width is 0.017 ms so that the one-line operation time is 0.026 ms in total. In this way, the operation is performed for a specified operation time corresponding to the line number. More specifically, in case the line number is less and when driving a line adjacent to the driver 420 on the drive side, the operation time is shortened. On the contrary, in case the line number is large and when driving a line spaced far from the drive-side driver 420, the operation time is made longer.

It should be noted that whereas panel inside electrodes on the drive side are made of thin film, panel inside electrodes on the scan side are thick-film electrodes by way of example. These thick-film electrodes have an electrical resistance value of 10Ω for example, which is negligibly small when compared to the resistance value on the drive side, e.g., 1 kΩ.

Additionally, an acceleration voltage of 5 kV for example as supplied from a high voltage circuit 900 is supplied to the panel 350.

Next, explanation will be given with a center focus on the light-emitting element part. FIGS. 5A-5B are diagrams for explanation of an equivalent circuit of one light-emitting element of the first embodiment of this invention and a drive circuit associated therewith. For explanation purposes, only a part relating to an operation of one light-emitting element is shown while omitting latch circuitry and shift register circuitry for matrix drive. FIG. 5A shows a circuit configuration of the first light-emitting element in close proximity to the drive circuit, and FIG. 5B shows a circuit of a light-emitting element spaced far from the drive circuit.

As previously described with reference to FIGS. 2 to 4, a single light-emitting element is connected to scan drive and data drive circuits. In FIG. 5A, a light-emitting element 300 is represented as equivalent circuitry. More specifically, a zener diode 320 and a diode 330 are connected in series to each other, with a capacitor 310 being parallel-connected thereto. Other circuit elements include a panel-inside wiring line resistance component 340, i.e., the above-stated internal resistance of lower electrode, which is connected in series. Shown in FIG. 5A is a case at the first light-emitting element immediately next to the drive circuit, wherein the panel-inside wire resistance 340 becomes a resistor of one light-emitting element, e.g., 1.3Ω. To perform a light emission operation, it is needed to apply a prespecified voltage to the light-emitting element 300. An operation of the light-emitting element is achievable by causing both of the scan drive circuit and the data drive circuit to operate.

Firstly, at the data drive circuit side, digital data as input from the data input 450 is converted by D/A converter 410 into an analog signal and then driven by a data driver 421 for applying a voltage to the light-emitting element 300. At this time, the voltage to be supplied from the data power supply 620 is employable as the reference voltage of D/A converter circuit. A voltage change range due to D/A conversion is defined by the voltage of the data power supply 620.

Next, on the scan drive circuit side, at the gate A 520 to which a scan signal 741 and a select signal 551 are input, a signal with coincidence of these signals is sent to the switch A 510. At this time, the switch A 510 is arranged to select for output either one of the positive (plus) side and ground side of the scan power supply 610. In other words, either one of the potential levels of the positive-side and the ground of scan power supply 610 is supplied via the switch A 510 based on the scan pulse signal and select signal.

Summarizing the operation of the light-emitting element, the voltage supplied to the light-emitting element 300 is such that a certain voltage is supplied which is due to combination of the positive-side voltage that is the voltage of the scan power supply 610 on the scan drive circuit side and the negative (minus)-side voltage as defined by the data power supply 620 on the data drive circuit side. For example, supposing that a voltage of +7 V is supplied from the scan drive circuit side while a voltage of −1.5 V is fed from the data drive circuit side, 8.5 V voltage with a potential difference therebetween is applied to the element. Obviously, the voltage on the data drive circuit side is variable in potential depending on an output from the D/A converter circuit 440, so the above-stated value of −1.5 V is a value which is set up based on data of specific brightness and is the one that changes in various ways during a display operation.

FIG. 5B shows an equivalent circuit of a light-emitting element 305 that is far from the data drive circuit by, for example, a distance corresponding to 768 elements and its associated drive circuit. More specifically, the light-emitting element 305 includes a series circuit of zener diode 325 and diode 335 with a capacitor 315 being coupled in parallel thereto. Further, in the panel, 768 resistance components corresponding in number to the elements are present as internal resistors. It has a series circuit of 768 resistors, including a resistor 340 immediately adjacent to the drive circuit, a second resistor 341, . . . , a 767-th resistor 344, and a 768-th resistor 345. This is the internal resistance of lower electrode stated supra. Calculating a total sum of 768 resistance values, it becomes a resistor with its resistance of 1,000Ω as an example. Additionally, each element that is not yet driven becomes in a ground-coupled state as equivalent circuitry at a non-select time. Thus, it becomes in a state that those capacitance component values of respective elements, e.g., 10 pF for each, are queued in parallel by the number of elements-in this case, 768. In other words, the first capacitor 310, second capacitor 311, . . . , 767-th capacitor 314 are present in a parallel way.

Regarding an operation of element peripheral circuitry in FIG. 5B, it is possible to drive it in a similar way to that of FIG. 5A. However, in the case of this example of FIG. 5B, within a transient time period of from activation of the drive circuit up to actually becoming a predetermined voltage, a delay can take place due to actions owned by the capacitors 310 to 315 existing in parallel with the element and the resistors 340 to 345. Concerning this delay, detailed explanation will be given with reference to FIGS. 8A-8B.

FIG. 6 is an explanation diagram showing a combination of resistors and capacitors of the first embodiment of this invention. For detailed explanation of the contents as stated in FIG. 5B, a part for generation of a delay of drive waveform is depicted in greater detail. A drive voltage to be sent from the D/A circuit 410 is sent out toward a data line 411 based on the data as input from data input terminal 450 within the range of the voltage of the drive power supply 620. Then, a data signal is sent to a first column driver A 421, followed by transmission of a signal to an element array within the panel 350. Inside of the panel, there are further internal resistors, i.e., 768 resistors corresponding in number to the elements. It has a series connection of 768 resistors, such as the resistor 340 immediately next to the drive circuit, second resistor 341, . . . , 767-th resistor 344 and 768-th resistor 345. This is the internal resistance of lower electrode as stated previously. Calculating a total sum of 768 resistance values, it becomes a resistor with its resistance of, e.g., 1,000Ω. Additionally, each element that is not yet driven becomes in a ground-coupled state as equivalent circuitry at a non-select time. Thus, it becomes in a state that those capacitance component values of respective elements, e.g., 10 pF for each, are queued in parallel by the number of elements—in this case, 768. In other words, the first capacitor 310, second capacitor 311, . . . , 767-th capacitor 314 are present in a parallel way.

The 768-th element 305 is presently selected, causing the 768-th capacitor 315 to be connected in parallel to the series circuit of zener diode 325 and diode 335, which is an equivalent circuit of the element. In this select state, the positive side of the scan power supply 610 is connected. Here, assume for example that an output voltage of D/A converter 410 is −1.5 V based on input image data whereas the voltage of the scan power supply 610 is at 7.0 V. Suppose that a flowing current is a micro-current of 0.001 mA or more or less. If this is the case, the voltage to be applied to the 768-th element 305 becomes about 8.5 V in total.

At this time, when looking at from the driver A 421 side, it operates as a capacitor of about 0.0768 μF as a result of combination of parallel-coupled 768 capacitance components in case a total value of serial coupled resistors, e.g., 768 capacitors, is set at 1,000Ω, and thus functions as a low-pass filter (LPF). When applying a drive waveform to the final stage of light-emitting element 305, a waveform delay can occur as a matter of course.

FIG. 7 shows an exemplary relationship of current versus application voltage of an electron emitter, which is the element for performing light emission in accordance with the first embodiment of the invention. This current-voltage characteristic is represented, in a sense of circuitry, as a combined characteristic of zener diode and diode as has been stated with reference to FIGS. 4 and 5. More specifically, in the case where a total sum of two voltages—i.e., a voltage of 7.0 V which is equivalent to a zener voltage E1 at 740 of zener diode and a voltage of 2.0 V equivalent to a diode voltage E2—is set, for example, at 9.0 V as indicated by E20 at 760, an operating current I2 at 810 of 0.02 mA for example flows, resulting in execution of a light emission operation. The resultant amount of emitted light at this time increases and decreases in conjunction with the operation current: the larger the operation current, the more the brightness. When the diode voltage is at −1.5 V as an example, the total application voltage E30 at 761 becomes 7.0 V+1.5 V=8.5 V. Its corresponding current I3 at 814 becomes 0.015 mA for example. In this way, the brightness of emitted light is controlled.

FIGS. 8A-8B are explanation diagrams each showing some major voltage waveforms to be applied to a single element of an electron emitter which is part of the element for performing light emission in the first embodiment.

FIG. 8A shows drive waveforms of the first line near the drive circuit while indicating a voltage waveform of a point A shown in FIG. 5A as a zener voltage waveform 650, a voltage waveform shown at a point B as a diode voltage waveform 660, and a drive voltage waveform 670 shown at a point C thereof, respectively. The zener voltage waveform 650 is such that the applied voltage E1 of 7.0 V for example is directly applied without changes. For the diode voltage waveform 660, a voltage almost equal to the voltage E2 as applied to the driver circuit side is applied, although it becomes a little-delayed waveform with a time constant with respect to the applied voltage E2. In FIG. 8B, drive waveforms are shown at the 768-th element for example, which is far from the drive circuit. In this FIG. 8B, the above-stated voltage waveform at point A′ of FIG. 5B is indicated by a zener voltage waveform 650, the voltage waveform shown at point B of the same is indicated by a diode voltage waveform 690, and the drive voltage waveform 700 shown at point C′ of the same is shown respectively.

Next, practical drive conditions will be explained. The explanation will be given while referring to FIGS. 5A-5B and FIGS. 8A-8B. The voltage waveform 710 at point D of FIG. 5A in FIG. 8A which is the voltage waveform of the first line is the latch signal as stated in FIG. 4. In response to this latch signal, the driver 421 is rendered operative, causing a voltage on the drive side to be output to the point B of FIG. 5A. Then, a delayed drive waveform with a time constant is applied to the light-emitting element, resulting in appearance of the waveform 670 at point C of FIG. 5A. Subsequently, the scan circuit begins to operate, causing a scan voltage to be applied as indicated by the waveform 650 of FIG. 5A, resulting in application of a voltage as needed for the light emission operation. An exemplary output of the driver 421 is a voltage with its potential of −1.5 V. At this time, the internal impedance of the driver 421 is 0.1Ω for example, which is a negligible value that is much smaller than the value, e.g., 1.39Ω, of the internal resistance A 340 that is the impedance of a data line on the panel 350 side. To make a long story short, a voltage of −1.5 V is applied to the diode 330 side of the element. Meanwhile, during an operation of the scan side, an output voltage of the switch circuit 510 is applied to the first line. Assuming at this time that the voltage of the scan power supply 610 is 7.0 V, the voltage to be applied to the zener diode 320 side of the element becomes 7.0 V. At this time, a voltage being applied to the entirety of such element becomes 7+1.5=8.5 V. The relation of an operating voltage at this time and a current flowing in the element permits it to perform a light emission operation at a level of brightness corresponding to 8.5 V as has been described with reference to FIG. 7.

Explanation will be given in a viewpoint of the operating time. FIG. 8A is for an operation in the case of driving a light-emitting element near the drive unit of an initially driven line, e.g., first line, of the display of one screen. Those voltage waveforms which are actually applied to the light-emitting element include a voltage waveform at point C which is delayed when compared to the waveform of point B on the drive side. In other words, the waveform that is driven by the driver 421 is delayed by the resistor 340 and capacitor 310 and others, which reside in a half-way. In this example of FIG. 8A, a time period t2 at 911 of the latch signal of the waveform 710 at point D is 0.001 ms, for example. Within this period of 0.001 ms, the delay of the drive waveform of point C is stabilized, resulting in a prespecified voltage E2 being arrived at −1.5 V by way of example. Thereafter, the scan voltage waveform 650 to be applied to the zener diode side is applied, allowing the light-emitting element to perform a light emission operation. A time period for execution of this light emission operation is indicated by t1 at 910; for example, the light emission operation is performed for 0.017 ms.

FIG. 8B is an operation in the case of driving a light-emitting element which is at the last line, e.g., 768-th line, of one screen and which is spaced far from the drive unit. Voltage waveforms that are actually applied to the light-emitting element include a waveform at a point C′″ which is delayed in comparison with a waveform at point B′″ on the drive side. In other words, the waveform that is driven by the driver 421 is delayed by a low-pass filter as formed by 768 resistors 340 to 345 and 768 capacitors 310-315 in mid course. In this example of FIG. 8B, a time period t4 at 913 of the latch signal of the waveform 711 at point D′″ is 0.009 ms, for example. Within this period of 0.009 ms, the delay of the drive waveform of point C′″ is stabilized, resulting in a prespecified voltage E2 being arrived at −1.5 V as an example. Thereafter, the scan voltage waveform 650 to be applied to the zener diode side is applied, allowing the light-emitting element to perform a light emission operation. A time period for execution of this light emission operation is indicated by t1 at 910; for example, the light emission operation is performed for 0.017 ms.

As shown in FIGS. 8A-8B, it is possible, by applying the scan voltage after arrival at a specified voltage after stabilization of the actual drive voltage waveform and then performing a light emission operation for a predetermined length of time period, to perform the display at constant brightness in any events.

In addition, by performing light emission while setting up an appropriate arrival time depending upon variability of the delay time in a way pursuant to the brightness to be displayed even in case where the applied voltage is −1.0 V at E3 at 930 for example, or at −0.5 V at E4 at 9.40, it is possible to perform the light emission operation with constant brightness at all times. FIG. 9 is a drive waveform chart showing a display operation of one screen in the first embodiment of this invention. Drive waveforms to be applied to light-emitting elements of the first line are indicated by a scan waveform 650 of point A, a drive waveform 660 of point B, and an applied drive waveform 670 of point C. A light emission time is, for example, 0.017 ms at an operation time t1 of the scan waveform 650. An exemplary operation time of one line becomes 0.018 ms of t3. Drive waveforms to be applied to light-emitting elements of the second line are indicated by a scan waveform 651 of point A′, a drive waveform 661 of point B′, and an applied drive waveform 671 of point C′. The light emission time is, e.g., 0.017 ms at an operation time t1 of the scan waveform 651. An exemplary one-line operation time is 0.0185 ms of t30. Drive waveforms to be applied to light-emitting elements of the 768-th line are indicated by a scan waveform 655 of point A′″, a drive waveform 665 of point B′″, and an applied drive waveform 675 of point C′″. The light emission time is, e.g., 0.017 ms at an operation time t1 of the scan waveform 655. An exemplary one-line operation time becomes 0.026 ms of t5. By gradually lengthening the operation time in a way corresponding to a line number to be operated, it becomes possible to achieve light emission at the same brightness even upon occurrence of a delay time of drive waveform.

It is also possible to set up a per-line operation time within a total one-screen operation time period. This makes it possible to allow the display operation to offer its inherent proper operability without causing the one-screen operation time to become irregular.

### Embodiment 2

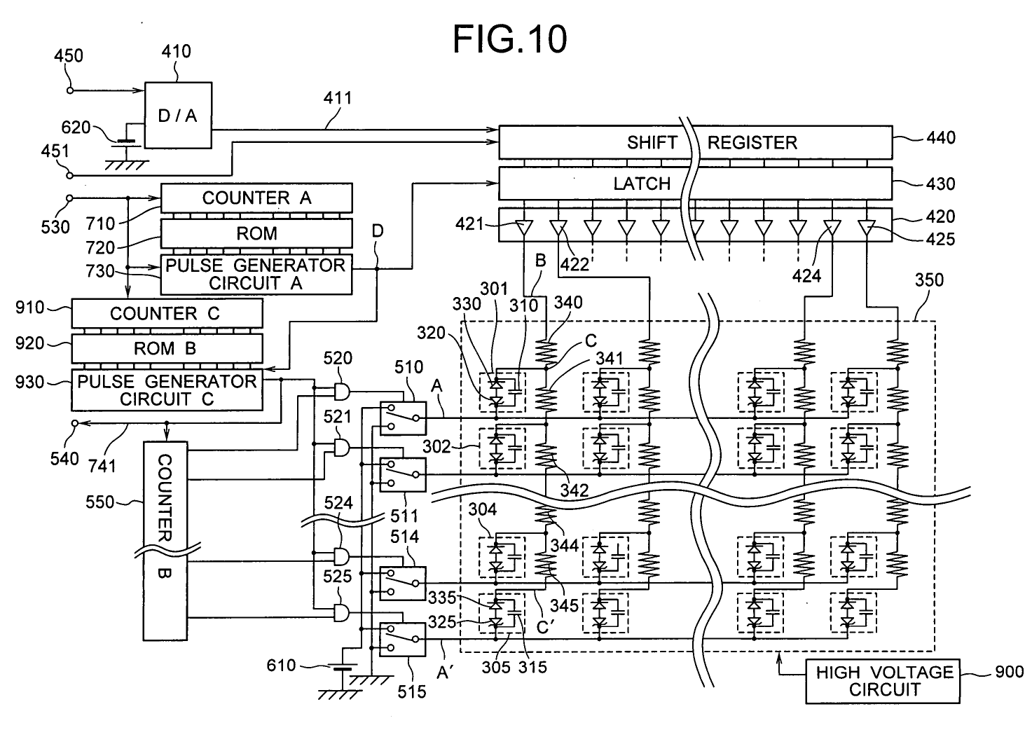

FIG. 10 is a block diagram showing an overall circuit configuration of a second embodiment. Explanations of similar parts or components to those of the first embodiment are omitted herein, and only different portions of the second embodiment from the first embodiment will be explained below.

This second embodiment is arranged not only to change a one-line display operation time during a display operation of a single line making up the display of one screen but also to modify the ratio of a lighting time to a rest time during the display operation time.

In FIG. 10, a signal for startup of a one-line display operation is generated with a pulse signal from the scan signal terminal 530 being as a trigger.

The scan signal is sent from the control unit (not shown) per one-line operation. The input pulse-shaped signal is sent to a counter A 710, pulse generator circuit A 730 and counter C 910. At this time, the counter A 710 counts up the number of input pulses and then sends its result to the ROM 720 as a line number. At ROM 720, the information being stored therein is read out of it based on the counted line number and is then sent as pulse width data to the pulse generator circuit A 730. The pulse generator circuit A 730 is responsive to receipt of the pulse width data as sent thereto, for outputting to a latch signal line 731 certain pulse width values; for example, 0.001 ms for the first line, 0.005 ms for the 374-th line, and 0.009 ms for the 768-th line. Meanwhile, the counter C 910 counts up the number of input pulses and then sends its result to ROM B 920 as a line number. At ROM B 920, the data being stored therein is read based on the counted line number and is then sent as pulse width data to a pulse generator circuit C 930. The pulse generator circuit C 930 is responsive to receipt of the pulse width data as sent thereto, for outputting to a latch signal line 741 certain pulse width values; for example, 0.015 ms for the first line, 0.022 ms for the 374-th line, and 0.028 ms for the 768-th line.

The pulse that was generated at the pulse generator circuit C 930 with the pulse of latch signal as a trigger is sent to the counter B 550. The counter B 550 switches between lines to be sequentially output on a per-latch signal basis. More specifically, the initially identified first output line becomes a first line portion, for permitting a line connected to the gate A 520 to operate. At this time, the gate A 520 takes AND operation of a pulse being sent from the pulse generator circuit C 940 and a signal as sent from the counter B 550, and then sends its output to the switch A 510. During a light emission operation of the first line, the switch A 510 is made operative within a time period corresponding to the width of a pulse to be output from the pulse generator circuit B 740, e.g., for 0.015 ms, to apply the voltage of the scan power supply 610, e.g., 9 V, to a scan line A 351. During an operation of the second line, the gate B 521 is rendered operative for activation of a switch B 511 to thereby drive a scan line B 352, thereby operating for a time corresponding to the pulse width, e.g., 0.017 ms, as stated previously. In this way, during an operation of the 768-th line, a scan line D 355 is driven to operate for the time of the pulse width, e.g., 0.019 ms, resulting in completion of a display operation of one screen.

At the control unit (not shown), upon receipt of a signal from a scan terminal 540 for take out of the signal of the pulse generator circuit B 740, it determines that the one-line operation is ended, and then inputs a pulse for use as a startup signal to a scan signal terminal 530 that is expected to begin the next one-line operation. Within this session, the time of one-line operation becomes a total sum of the above-stated latch signal by means of the pulse generator circuit A 730 and the scan signal due to the pulse generator circuit C 930. The one-line operation time is such that at the first line for example, the latch signal width is 0.001 ms and the scan signal width is 0.015 ms so that a total time is 0.016 ms. At the 384-th line for example, the latch signal width is 0.005 ms and the scan signal width is 0.017 ms so that the one-line operation time becomes 0.022 ms in total. At the 768-th line for example, the latch signal width is 0.009 ms and the scan signal width is 0.022 ms, so the one-line operation time is 0.028 ms in total. In this way, the operation is performed for a specified operation time corresponding to the line number. More specifically, in case the line number is less and when driving a line adjacent to the driver 420 on the drive side, the operation time is shortened in both the rest time and the lighting time. On the contrary, in case the line number is large and when driving a line spaced far from the drive-side driver 420, the operation time is made longer both in rest time and in lighting time.

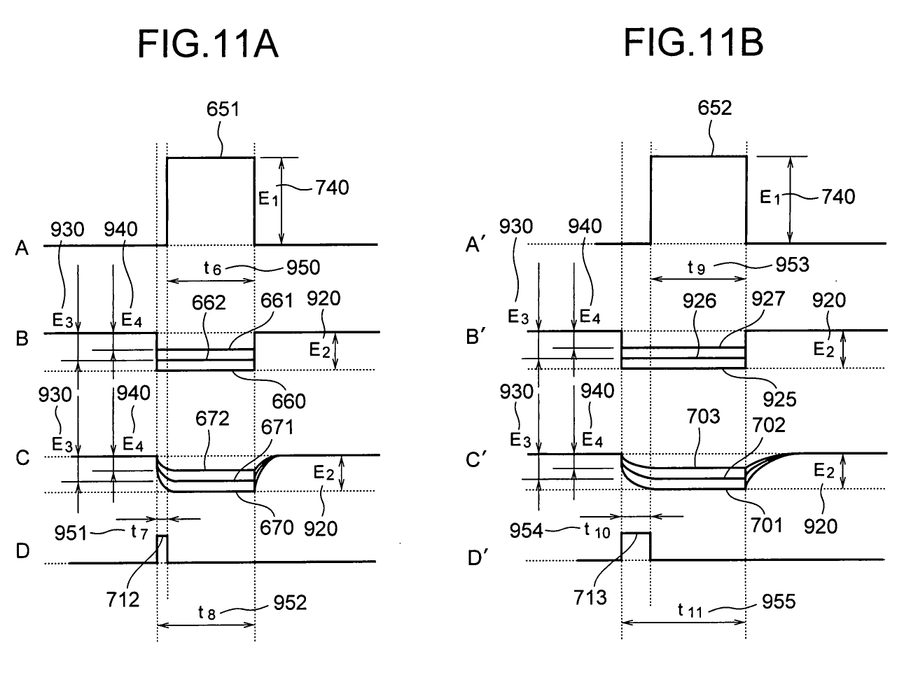

FIGS. 11A-11B are explanation diagrams showing major operation waveforms of the second embodiment. FIG. 11A shows waveforms at respective points A, B, C and D shown in FIG. 10, and FIG. 11B shows waveforms at respective points A′, B, C′ and D shown in FIG. 10.

Explanation will be given in a viewpoint of the operating time. FIG. 11A is an operation in the case of driving a light-emitting element near the drive unit of an initially driven line, e.g., first line, of the display of one screen. Those voltage waveforms which are actually applied to the light-emitting element include a voltage waveform at point C which is delayed when compared to the waveform of point B on the drive side. In other words, the waveform that is driven by the driver 421 is delayed by the resistor 340 and capacitor 310 and others, which reside in a half-way. In this example of FIG. 11A, a time period t7 at 951 of the latch signal of the waveform 712 at point D is 0.001 ms, for example. Thereafter, the scan voltage waveform 650 to be applied to the zener diode side is applied, allowing the light-emitting element to perform a light emission operation. A time period for execution of this light emission operation is indicated by t6 at 951; for example, the light emission operation is performed for 0.015 ms.

FIG. 11B is an operation in the case of driving a light-emitting element which is at the last line, e.g., 768-th line, of one screen and which is far from the drive unit. Voltage waveforms that are actually applied to the light-emitting element include a waveform at a point C′ which is delayed in comparison with a waveform at point B on the drive side. In other words, the waveform that is driven by the driver 421 is delayed by a low-pass filter as formed by 768 resistors 340 to 345 and 768 capacitors 310-315 in mid course. In this example of FIG. 11B, a time period t10, 954, of the latch signal of the waveform 713 at point D is 0.009 ms, for example. Within this period of 0.009 ms, the delay of the drive waveform of point C′ is not stabilized, resulting in failure of arrival at a prespecified voltage E2 of −1.5 V, for example. Thereafter, the scan voltage waveform 652 to be applied to the zener diode side is applied, causing the light-emitting element to perform a light emission operation. A time period for execution of this light emission operation is indicated by t9 at 953; for example, the light emission operation is performed for 0.019 ms.

As stated with reference to FIG. 10, the operation time per line is arranged so that both the rest time and the lighting time are gradually changed. Thus, it becomes possible to constantly retain the energy contributed to light emission even when performing the lighting operation prior to the stabilization of a voltage to be applied to a light-emitting element. This in turn makes it possible to display at specified brightness or luminance.

### Embodiment 3

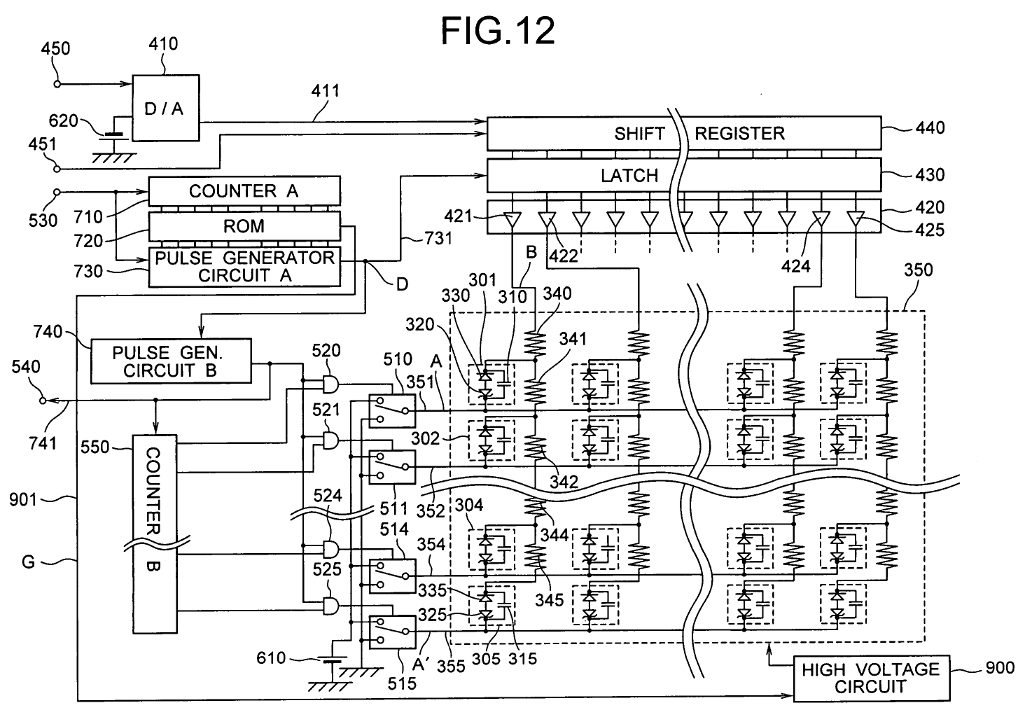

FIG. 12 is a diagram showing an overall circuit configuration of a third embodiment. Explanations of similar portions to those of the first and second embodiments are omitted herein, and only those portions of the second embodiment different from the other embodiments will be explained below.

The third embodiment is arranged to change or modify the acceleration voltage of electrons without varying the display operation time of one line during a display operation of one line making up the display of one screen. In FIG. 12, the signal for startup of a one-line display operation operates with a pulse signal from the scan signal terminal 530 being as a trigger. The scan signal is sent from a control means (not shown) on a per-line basis.

The input pulse-shaped signal is sent to a counter A 710 and pulse generator circuit A 730. At this time, the counter A 710 counts up the number of input pulses and then sends its result to ROM 720 as a line number. At ROM 720, the information as stored therein is read based on the counted line number and is then sent as pulse width data to the pulse generator circuit A 730. Simultaneously, the acceleration voltage data is sent from ROM 720 to a high voltage circuit 900 via a signal line 901. The pulse generator circuit A 730 is responsive to receipt of the pulse width data as sent thereto, for outputting to a latch signal line 731 certain pulse width values; for example, 0.001 ms for the first line, 0.005 ms for the 374-th line, and 0.009 ms for the 768-th line. The high voltage circuit 900 generates by the acceleration voltage data as sent thereto an acceleration voltage of 7.0 kV for the first line, 7.8 V for the 374-th line, and 8.8 kV for the 768-th line and then supplies it to the display panel 350. The light emission amount of the display panel changes due to variability of the acceleration voltage. Thus, modifying the acceleration voltage on a per-line basis makes it possible to adjust the brightness per one line.

The pulses of the latch signal are repulsed by the pulse generator circuit B 740 for transmission to the counter B 550. The counter B 550 performs switching between lines to be sequentially output on a per-latch signal basis. More specifically, the initially identified first output line becomes a first line portion, for permitting a line connected to the gate A 520 to operate. At this time, the gate A 520 takes AND operation of a pulse being sent from the pulse generator circuit B 740 and a signal as sent from the counter B 550, and then sends its output to the switch A 510. During a light emission operation of the first line, the switch A 510 operates within a time period corresponding to the width of a pulse to be output from the pulse generator circuit B 740, e.g., for 0.017 ms, to apply the voltage of the scan power supply 610, e.g., 9 V, to a scan line A 351. During an operation of the second line, the gate B 521 is rendered operative for activation of a switch B 511 to thereby drive a scan line B 352. With such a procedure, during an operation of the 768-th line, a scan line D 355 is driven, resulting in completion of a display operation of one screen.

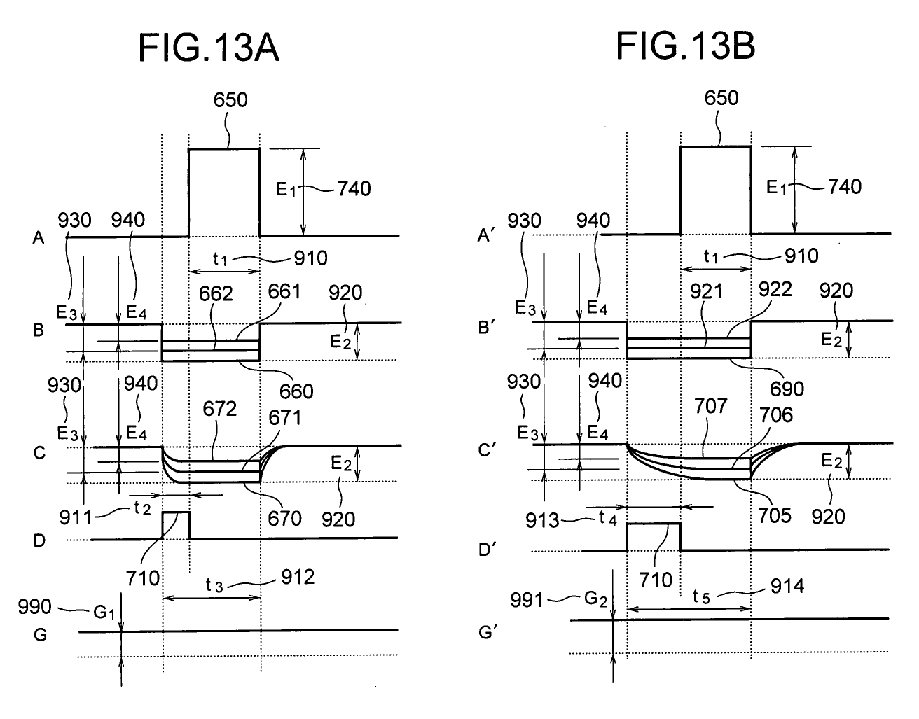

FIGS. 13A-13B show drive voltage waveforms at major portions in the third embodiment shown in FIG. 12. In FIG. 12, a voltage waveform at point G which is an output voltage from the high-voltage generator circuit 900 is at a potential level indicated by G1 at 990 during a light emission operation of the first line-for example, 7.0 kV. During a light emission operation of the 769-th line shown in FIG. 13B, an operation voltage waveform 705 at point C′ is not yet stabilized due to the influence of low-pass filter. The value indicated by an acceleration voltage G2 at 991 during a light emission operation at this 768-th line is set at 8.8 kV, for example. The remaining operations are performed for a prespecified operation time corresponding to a line number in a similar way to that as has been explained in the first embodiment. More specifically, in case the line number is less and when driving a line adjacent to the driver 420 on the drive side, the operation time is shortened. On the contrary, in case the line number is large and when driving a line spaced far from the drive-side driver 420, the operation time is made longer.

With such an arrangement for varying the operation time on a per-line basis and further modifying the high-potential acceleration voltage also in units of lines, it is possible to prevent irregularities of the brightness in one screen even in cases where the voltage to be applied to a light-emitting element is large in delay and thus its potential stabilization takes time. This makes it possible to achieve uniform screen displayability.

Although the embodiment explanation above is given based on a specific example having its display unit using electron emission elements, it is needless to say that similar effects and advantages are obtainable even for those using self-luminous light-emitting elements of other electronic display schemes, such as field emission elements, for example.

In addition, although in the above-noted embodiment explanation three representative embodiments have been described which have three principal features in regard to the technique for appropriately changing two time periods, i.e., the rest time and lighting time, within the operation time of one line and the scheme for modifying the acceleration voltage with a high potential level, it would readily occur to a skilled person that similar effects are still available even when employing other combinations—for example, an arrangement for modifying only the acceleration voltage while forcing the rest time and the lighting time to stay constant throughout all the lines involved.

Furthermore, although in the above-noted embodiments the scan-line drive circuit for sequential application of scan voltage pulses is installed at one end of an ensemble of scan lines, such may alternatively be provided at its both ends. Similarly, while the signal-line drive circuit which applies drive voltage pulses pursuant to an input video signal is situated at one end of a group of signal lines, a couple of similar circuits may alternatively be installed at both ends thereof.

It should be further understood by those skilled in the art that although the foregoing description has been made on embodiments of the invention, the invention is not limited thereto and various changes and modifications may be made without departing from the spirit of the invention and the scope of the appended claims.

1. A display apparatus comprising:
a plurality of scan lines;
a scan line drive circuit connected to at least either one of right and left ends of the plurality of scan lines, for sequentially applying a scan voltage pulse to the scan lines;
a plurality of signal lines;
a signal line drive circuit connected to the plurality of signal lines, for applying to these signal lines a drive voltage pulse pursuant to an input image signal;
an electron source connected to respective intersections of said plurality of scan lines and said plurality of signal lines, for giving off electrons in accordance with a potential difference between said scan voltage and said drive voltage; and
a control unit for controlling said scan line drive circuit and said signal line drive circuit in such a way that said drive voltage pulse becomes greater in width than said scan voltage pulse.

2. The display apparatus according to claim 1, wherein said control unit controls said scan line drive circuit and said signal line drive circuit so that a difference in width between said drive voltage pulse and said scan voltage pulse changes in accordance with a distance of said electron source and said signal line drive circuit.

3. The display apparatus according to claim 2, wherein said control unit controls said scan line drive circuit and said signal line drive circuit so that the difference in width between said drive voltage pulse and said scan voltage pulse becomes greater with an increase in the distance of said electron source and said signal line drive circuit.

4. The display apparatus according to claim 1, wherein said control unit controls said scan line drive circuit and said signal line drive circuit to cause said drive voltage pulse and said scan voltage pulse to change in width in accordance with a distance of said electron source and said signal line drive circuit.

5. The display apparatus according to claim 4, wherein said control unit controls said scan line drive circuit and said signal line drive circuit so that said drive voltage pulse and said scan voltage pulse become greater in width with an increase in the distance of said electron source and said signal line drive circuit.

6. A display apparatus comprising:
a plurality of signal lines;
a signal line drive circuit connected to the plurality of signal lines, for applying to these signal lines a drive voltage pulse pursuant to an input image signal;
an electron source connected to respective intersections of said plurality of scan lines and said plurality of signal lines, for emitting electrons in accordance with a potential difference between said scan voltage and said drive voltage; and
an acceleration voltage applying unit for applying an acceleration voltage for accelerating electrons as emitted from said electron source,
wherein the acceleration voltage to be applied by said acceleration voltage applying unit is varied in accordance with a distance of said electron source and said signal line drive circuit.

7. The display apparatus according to claim 6, wherein the acceleration voltage being applied by said acceleration voltage applying unit becomes greater with an increase in a distance of said electron source and said signal line drive circuit.

8. A display apparatus comprising:
a plurality of signal lines;
a signal line drive circuit connected to the plurality of signal lines, for applying to these signal lines a drive voltage pulse pursuant to an input image signal;
an electron source connected to respective intersections of said plurality of scan lines and said plurality of signal lines, for emitting electrons in accordance with a potential difference between said scan voltage and said drive voltage; and
a control unit for controlling said scan line drive circuit and said signal line drive circuit so that an application time of said drive voltage becomes longer than an application time of said scan voltage.

9. The display apparatus according to claim 8, wherein said control unit controls said scan line drive circuit and said signal line drive circuit so that a difference between the application time of said drive voltage and the application time of said scan voltage varies in accordance with a distance of said electron source and said signal line drive circuit.

10. The display apparatus according to claim 9, wherein said control unit controls said scan line drive circuit and said signal line drive circuit so that the difference between the application time of said drive voltage and the application time of said scan voltage becomes greater with an increase in the distance of said electron source and said signal line drive circuit.

11. The display apparatus according to claim 8, wherein said control unit controls said scan line drive circuit and said signal line drive circuit to change the application time of said drive voltage and the application time of said scan voltage in accordance with a distance of said electron source and said signal line drive circuit.

12. The display apparatus according to claim 11, wherein said control unit controls said scan line drive circuit and said signal line drive circuit so that the application time of said drive voltage and the application time of said scan voltage become greater with an increase in the distance of said electron source and said signal line drive circuit.

13. A display apparatus comprising:
a plurality of signal lines;
a signal line drive circuit connected to the plurality of signal lines, for applying to these signal lines a drive voltage pulse pursuant to an input image signal;
an electron source connected to respective intersections of said plurality of scan lines and said plurality of signal lines, for emitting electrons in accordance with a potential difference between said scan voltage and said drive voltage; and
a control unit for controlling said scan line drive circuit and said signal line drive circuit so that said drive voltage pulse becomes larger in width than said scan voltage pulse.

14. The display apparatus according to claim 13, wherein said control unit controls said scan line drive circuit and said signal line drive circuit so that a difference in width between said drive voltage pulse and said scan voltage pulse varies in accordance with a distance of said electron source and said signal line drive circuit.

15. The display apparatus according to claim 14, wherein said control unit controls said scan line drive circuit and said signal line drive circuit so that the difference in width between said drive voltage pulse and said scan voltage pulse becomes greater with an increase in the distance of said electron source and said signal line drive circuit.

16. The display apparatus according to claim 13, wherein said control unit controls said scan line drive circuit and said signal line drive circuit to cause said drive voltage and said scan voltage to vary in width in accordance with the distance of said electron source and said signal line drive circuit.

17. The display apparatus according to claim 16, wherein said control unit controls said scan line drive circuit and said signal line drive circuit so that said drive voltage pulse and said scan voltage pulse become greater in width with an increase in the distance of said electron source and said signal line drive circuit.
